(19) United States
(12) Patent Application Publication
(10) Pub. No.: US 2025/0245921 A1
(43) Pub. Date: Jul. 31, 2025

(54) IMAGE PROCESSING APPARATUS, THREE-DIMENSIONAL DATA GENERATION METHOD, AND STORAGE MEDIUM

(71) Applicant: CANON KABUSHIKI KAISHA, Tokyo (JP)

(72) Inventor: Kanji SUZUKI, Kanagawa (JP)

(21) Appl. No.: 19/032,493

(22) Filed: Jan. 21, 2025

(30) Foreign Application Priority Data
Jan. 30, 2024 (JP) 2024-012251

(51) Int. Cl. G06T 17/00; G06T 5/20

(52) U.S. Cl. CPC G06T 17/00; G06T 5/20; G06T 2200/08

(57) ABSTRACT

An image processing apparatus comprises a distance distribution information acquisition unit configured to acquire distance distribution information of an object based on an object image formed by an optical system, a region division unit configured to divide coordinate information of the object into a first region and a second region, and an offset unit configured to decrease a distance in an optical axis direction of the optical system between a first representative coordinate representing a coordinate of the first region and a second representative coordinate representing a coordinate of the second region.

### BACKGROUND OF THE INVENTION

### Field of the Invention

The present invention relates to an image processing apparatus, a three-dimensional data generation method, a storage medium, and the like.

### Description of the Related Art

Conventionally, technologies that enable the acquisition of distance distribution information, such as a stereo camera and a time-of-flight (ToF) camera, are known. The distance distribution information can be converted into a point cloud by perspective projection conversion.

Additionally, the point cloud can be converted into a three-dimensional surface model having a surface by polygonization. Furthermore, three-dimensional data that includes texture information can be generated by acquiring the color distribution information and the distance distribution information at the same time. Unlike a two-dimensional image, three-dimensional data has an advantage in that the data can be viewed from an arbitrary viewpoint.

However, in a case in which three-dimensional data is generated based on the distance distribution information from a single viewpoint, the three-dimensional data includes a region that exists in the actual object but cannot be reconstructed by the three-dimensional data itself.

For example, in a case in which a scene in which a hand is positioned in front of the body of a person is converted into three-dimensional data, a part of the body is occluded by the hand when the person is viewed from the front, and information is lost. Such a state is referred to as “occlusion”.

Additionally, for example, in a case in which such three-dimensional data is rendered from a viewpoint other than the front, the missing portions of the occluded region becomes visible, which may cause a sense of incongruity during viewing.

As a technology for solving such a drawback, for example, there is a technology disclosed in Document 1 (J. Kopf, “One Shot 3D Photography”, ACM Trans. Graph., Vol. 39, No. 4, Article 76., 2020).

In the technology disclosed in Document 1, inpainting processing for repairing loss portions is applied to a loss portion that occurs in a part of the background due to the occlusion of the foreground. This technology prevents occlusions from being visible even when the three-dimensional data is viewed from different perspectives by inferring the shape information and texture information of an occluded region and repairing the loss portion through inpainting processing based on deep learning.

However, since the technology disclosed in Document 1 infers the information on the loss portion based on deep learning, there is a concern that information that is significantly different from the actual object is provided, which may cause a stronger sense of incongruity. Additionally, in general, the use of deep learning requires a large calculation cost.

### SUMMARY OF THE INVENTION

In order to solve the above-described drawback, an image processing apparatus of the present invention comprises a distance distribution information acquisition unit configured to acquire distance distribution information of an object based on an object image formed by an optical system, a region division unit configured to divide coordinate information of the object into a first region and a second region, and an offset unit configured to decrease a distance in an optical axis direction of the optical system between a first representative coordinate representing a coordinate of the first region and a second representative coordinate representing a coordinate of the second region.

Further features of the present invention will become apparent from the following description of embodiments with reference to the attached drawings.

### BRIEF DESCRIPTION OF THE DRAWINGS

FIG. 1 is a flowchart illustrating an example of three-dimensional data generation processing according to the embodiment.

FIGS. 2A to 2C are diagrams illustrating an example of region division according to the embodiment.

FIGS. 3A to 3C are diagrams illustrating another example of region division according to the embodiment.

FIGS. 4A to 4C are diagrams illustrating still another example of region division according to the embodiment.

FIGS. 5A and 5B are diagrams for explaining that the appearance of an occluding region is reduced by adding an offset value according to the embodiment.

FIG. 6 is a diagram illustrating an example of a first neighboring region and a second neighboring region according to the embodiment.

FIG. 7 is a flowchart illustrating an example of three-dimensional data generation processing according to a modification of the embodiment.

FIG. 8 is a flowchart illustrating an example of three-dimensional data generation processing according to another modification of the embodiment.

FIG. 9 is a diagram for explaining that the appearance of the occluding region is reduced by adding an offset value according to another modification of the embodiment.

FIG. 10 is a diagram illustrating an example of a hardware configuration of an image processing apparatus according to the embodiment.

FIGS. 11A and 11B illustrate an example of an imaging unit according to the embodiment.

FIG. 12 is a diagram illustrating an example of the relationship between a defocus amount and an image shift amount of the imaging unit according to the embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate descriptions will be omitted or simplified.

First, definitions of terms used in the embodiments of the present invention will be explained. Three-dimensional data is data that includes shape information indicating a three-dimensional shape, and is, for example, data representing a point cloud or a three-dimensional surface model. Additionally, the three-dimensional data may include color information indicating a color, in addition to the shape information.

When a point cloud is rendered, the point cloud is typically expressed in a format in which point-like objects having a finite size are arranged at the position of each point that configures the point cloud. In a case in which a rendering result of the point cloud is shown in the drawings below, the result is shown according to this format.

Coordinate information is two-dimensional information that indicates coordinates in distance distribution information to be described below. Alternatively, the coordinate information is three-dimensional coordinates of each point that configures the point cloud.

The Z-axis extends from an origin of a light-receiving surface of a distance distribution information acquisition unit, for example, a stereo camera, a ToF camera, and an imaging element of an imaging surface phase difference ranging method, which is an axis parallel to an optical axis of the distance distribution information acquisition unit. The X-axis and the Y-axis are located in a plane perpendicular to the Z-axis and are orthogonal to each other.

The distance distribution information is information in which the distance to each point of the object is projected onto the XY plane. In a case in which the distance distribution information is shown in the drawings below, the distance is expressed in grayscale, in which closer distances appear closer to white, and farther distances appear closer to black. Additionally, one of the elements constituting the distance distribution information is referred to as a pixel.

The image and the two-dimensional image refer to texture information that indicates a texture of the object and color distribution information that indicates a color of the object.

An occluded region is a region in which the coordinate information of the object cannot be acquired by the distance distribution information acquisition unit because the region is occluded by an occluding region. The occluded region becomes lost on the three-dimensional data.

An occluding region is a region that obscures the occluded region from the viewpoint of the distance distribution information acquisition unit, making it impossible to obtain the coordinate information of the occluded region. Note that, in the distance distribution information projected on the two-dimensional plane, the occluding region and the occluded region coincide with each other.

In a case in which the coordinate information is the distance distribution information, each of first region and second region becomes a two-dimensional region, and in a case in which the coordinate information is the three-dimensional coordinates of each point constituting the point cloud, each of the first region and the second region becomes a three-dimensional region.

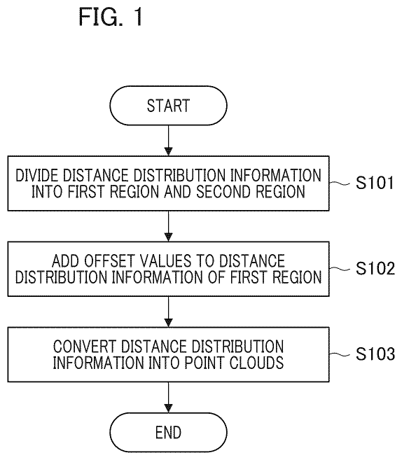

FIG. 1 is a flowchart illustrating an example of three-dimensional data generation processing according to the embodiment.

### <Region Division Process Step S101>

Step S101 is executed by a region division unit within an image processing apparatus. In step S101, the region division unit divides the distance distribution information, which is an example of the coordinate information of the object, into a first region and a second region. The region division unit sets the foreground, including the occluding region, as the first region and sets a region other than the foreground including the occluding region as the second region.

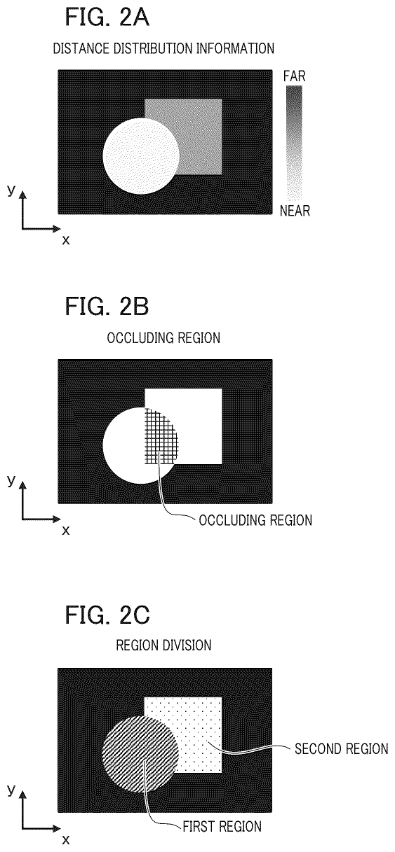

FIG. 2 is a diagram illustrating an example of region division according to the embodiment. FIG. 2A illustrates an example of distance distribution information in a case in which a circular object is positioned as the foreground and a quadrangular object is positioned behind the circular object as the background.

FIG. 2B illustrates a region occluded by a circular object in a quadrangular object. FIG. 2C illustrates an example of the first region and the second region in the case of the distance distribution information as shown in FIG. 2A and FIG. 2B. The region division unit divides the coordinate information of the object into the first region and the second region so that the occluding region that occludes the occluded region is included in the first region.

In the case of the distance distribution information as shown in FIG. 2A, the region division unit recognizes a region indicated by hatching in FIG. 2B, that is, a region in which a circular object and a quadrangular object overlap with each other as an occluding region (and an occluded region).

Then, in the case of the distance distribution information as shown in FIG. 2A, the region division unit sets a region indicated by diagonal hatching in FIG. 2C, that is, a region of the circular object as the first region. Additionally, in the case of the distance distribution information as shown in FIG. 2A, the region division unit sets a region indicated by dot hatching in FIG. 2C, that is, a region of the quadrangular object that does not overlap with the circular object, as the second region.

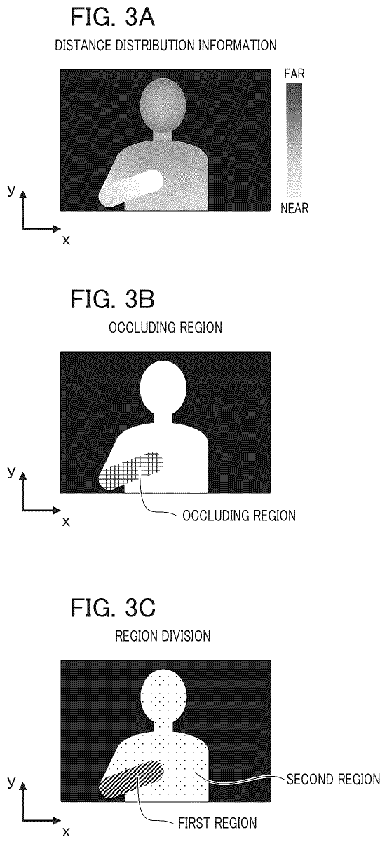

FIG. 2A to FIG. 2C illustrate a case in which a plurality of objects are present. However, even if only one object is present, a part of the object may occlude another part of the object. FIG. 3A to FIG. 3C are diagrams that illustrate another example of region division according to the embodiment.

FIG. 3A illustrates an example of the distance distribution information in a case in which a person extends a portion from the right elbow to the right hand in front of the body. FIG. 3B illustrates a region occluded by a portion from the right elbow to the right hand of the human body. FIG. 3C illustrates an example of the first region and the second region in the case of the distance distribution information as shown in FIG. 3A and FIG. 3B.

In the case of the distance distribution information as shown in FIG. 3A, the region division unit recognizes a region indicated by hatching in FIG. 3B, that is, a region in which a portion from the right elbow to the right hand overlaps with the body, as an occluding region (and an occluded region).

Then, in the case of the distance distribution information as shown in FIG. 3A, the region division unit sets the region indicated by diagonal hatching in FIG. 3C, that is, the region of the portion from the right elbow to the right hand as the first region. Additionally, in the case of the distance distribution information as shown in FIG. 3A, the region division unit sets a region indicated by dot hatching in FIG. 3C, that is, a region that does not overlap with the portion from the right elbow to the right hand of the body, as the second region.

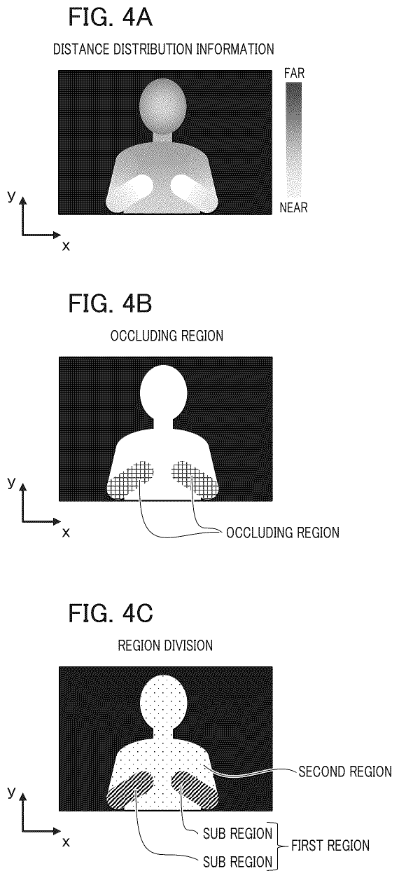

FIG. 4A to FIG. 4C are diagrams illustrating still another example of region division according to the embodiment. FIG. 4A illustrates an example of the distance distribution information in a case in which a person extends the portion from the left elbow to the left hand and the portion from the right elbow to the right hand in front of the body.

FIG. 4B illustrates regions of the human body occluded by the portions from the left elbow to the left hand and from the right elbow to the right hand. FIG. 4C illustrates an example of the first region and the second region in the case of the distance distribution information as shown in FIG. 4A and FIG. 4B.

In the case of the distance distribution information as shown in FIG. 4A, the region division unit recognizes a region indicated by hatching in FIG. 4B, that is, a region in which a portion from the left elbow to the left hand or a portion from the right elbow to the right hand overlaps with the body as an occluding region (and an occluded region).

Next, in the case of the distance distribution information as shown in FIG. 4A, the region division unit sets two regions indicated by diagonal hatching in FIG. 4C, that is, the region of the portion from the left elbow to the left hand and the region of the portion from the right elbow to the right hand portion, as sub regions.

Then, the region division unit sets these two sub regions as the first region. Additionally, in the case of the distance distribution information as shown in FIG. 4A, the region division unit sets a region indicated by dot hatching in FIG. 4C, that is, a region that does not overlap the portion from the left elbow to the left hand of the body and the portion from the right elbow to the right hand of the body, as the second region.

That is, in the case of the distance distribution information as shown in FIG. 4A, the region division unit divides the coordinate information of the object into the second region and the first region that includes a plurality of sub-regions that are not connected to each other.

The region division unit executes the region division as described above, for example by segmentation based on deep learning. In particular, in a case in which the object is a person, the body is often occluded by a hand, an arm, and the like.

In such a case, the region division unit can appropriately execute region division by using a model that has learned to assign different labels to a region of a hand, an arm, and the like and a region other than the region.

### <Offset Addition Process Step S102>

Step S102 is executed by an offset addition unit serving as an offset unit within the image processing apparatus. In step S102, the offset addition unit adds an offset value to the distance distribution information of the first region.

Here, the offset value is set so as to minimize the distance between a first representative coordinate representing the coordinates of the first region and a second representative coordinate representing the coordinates of the second region. Additionally, this distance is a distance in the optical axis direction of the distance distribution information acquisition unit, which is used to acquire the coordinate information of the object.

Additionally, the offset addition unit calculates the first representative coordinate by applying a certain rule to a set of coordinates of points that belong to the first region. Similarly, the offset addition unit calculates the second representative coordinate by applying a certain rule to a set of coordinates of points that belong to the second region.

The offset addition unit may set, for example, the coordinate of the point nearest to the center of gravity in the XY plane of the first region as the first representative coordinate, and set the coordinate of the point nearest to the center of gravity in the XY plane of the second region as the second representative coordinate.

However, the offset addition unit can calculate the first representative coordinate and the second representative coordinate by any method. Additionally, at least one of the calculations of the first representative coordinate and the calculation of the second representative coordinate may be executed by a unit other than the offset addition unit.

A far-near conflict edge (depth discontinuity edge) exhibits a boundary in which the distance of the distance distribution information acquisition unit in the optical axis direction changes discontinuously. A point cloud is an example of the coordinate information of an object, and in a case in which the far-near conflict edge is included, a difference in distance in the optical axis direction of the distance distribution information acquisition unit becomes larger around the far-near conflict edge. In a case in which such a point cloud is visually recognized from a viewpoint that is not parallel to the optical axis direction, a portion in which the difference is large is visually recognized as a gap.

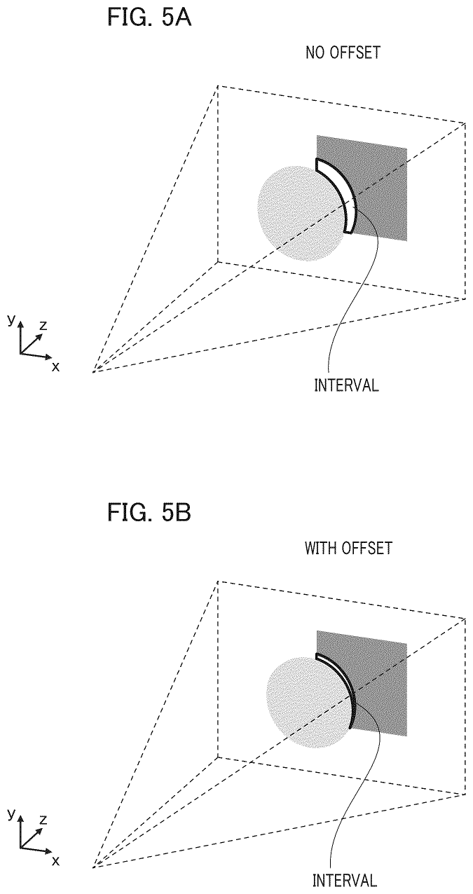

FIG. 5A and FIG. 5B are diagrams for explaining that the appearance of the occluding region is reduced by adding the offset value according to the embodiment. FIG. 5A shows an example of a case of the three-dimensional data generated by converting the distance distribution information into a point cloud as shown in FIG. 2A, viewed from a perspective that is not parallel to the optical axis, and without the addition of an offset value.

This gap is caused by the appearance of the background region occluded by the foreground, that is, the occluded region. In a case in which the occluded region appears, a gap, that is, a region in which information is not present is generated in a region in which information is actually present or a region in which information is expected to be present, and thus a person who visually recognizes the point cloud feels significant incongruity.

FIG. 5B shows an example of a case of the three-dimensional data generated by converting the distance distribution information into a point cloud as shown in FIG. 2A, viewed from a view point that is not parallel to the optical axis, and with the addition of an offset value.

As described above, the offset addition unit adds the offset value to the coordinate information of the first region so as to minimize the distance between the first representative coordinate and the second representative coordinate in the optical axis direction. Thus, as shown in FIG. 5B, the offset addition unit reduces the difference in distance at the near-far boundary edge between the first region and the second region.

That is, the offset addition unit reduces the gap by reducing the degree of far-near conflict between the first region and the second region at the far-near boundary edge. Therefore, the offset addition unit can reduce the sense of incongruity in a case in which the three-dimensional data is visually recognized from a viewpoint that is not parallel to the optical axis direction of the distance distribution information.

Note that the offset addition unit adds the offset value to the coordinate information of the first region, thereby generating three-dimensional data that is different from the actual positional relation of the object when the distance distribution information is acquired.

However, since the offset addition unit does not change the shape information of the object in the first region and the shape information of the object in the second region, the sense of incongruity caused by the positional relation change due to the added offset value can be sufficiently minimized. As a result, the image processing apparatus can reduce the sense of incongruity in viewing in three-dimensional data including occlusions.

As described above, FIG. 5 shows three-dimensional data generated based on a point cloud. In a case in which the three-dimensional data is turned into a surface, since the points existing across the far-near conflict edge also form a polygon, the gap as shown in FIG. 5 is filled with the polygon.

Additionally, in a case in which the three-dimensional data to which the texture has been applied is turned into a surface, the texture on the polygon that has been formed by the points existing across the far-near conflict edge is obtained by extending the color information around the far-near conflict edge.

In these two cases, the polygons formed by the points that are present across the far-near conflict edge are not present in the actual object, and as the difference in distance around the far-near conflict edge is larger, these polygons becomes larger. Even in these two cases, the image processing apparatus can reduce the sense of incongruity in viewing in three-dimensional data including occlusions.

Note that the region division unit may set, as the first representative coordinate, a statistical amount of coordinates of a first neighboring region that, among the first region, is located near a boundary with the second region. Additionally, the region division unit may set, as the second representative coordinate, a statistical amount of coordinates of a second neighboring region that, among the second region, is located near a boundary with the first region.

As described above, it is necessary to reduce the degree of far-near conflict between the first region and the second region in order to reduce the sense of incongruity in viewing in three-dimensional data. Therefore, it is preferable that the region division unit sets the amount of statistics of the coordinates of the first neighboring region as the first representative coordinate and sets the statistical amount of the coordinates of the second neighboring region as the second representative coordinate in order to reduce the degree of far-near conflict in the vicinity of the boundary between the first region and the second region. Additionally, the statistical amount is, for example, an average value, a median value, a mode value, and the like.

The first neighboring region is the region enclosed by the pixels corresponding to the boundary between the first region and the second region and the pixels located within a predetermined distance toward the first region. Similarly, the second neighboring region is the region enclosed by the pixels corresponding to the boundary between the first region and the second region and the pixels located within a predetermined distance toward the second region.

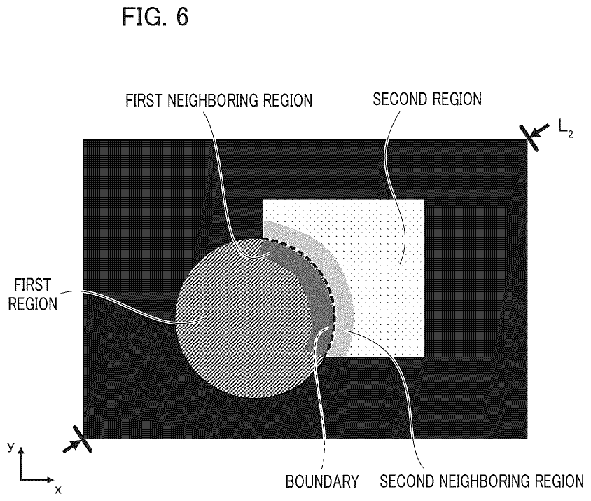

FIG. 6 is a diagram illustrating an example of the first neighboring region and the second neighboring region according to the embodiment. In FIG. 6, the first neighboring region is indicated by a region filled with a relatively dark color, and the second neighboring region is indicated by a region filled with a relatively light color.

In this context, a predetermined length may be determined to be, for example, 20 pixels with an index such as four neighbors from the pixel corresponding to the boundary between the first region and the second region. Alternatively, in a case in which the length of the diagonal line in the entire distance distribution information is L₂ pixels, the predetermined length may be determined as 0.05×L₂ pixels from the pixels corresponding to the boundary between the first region and the second region.

Additionally, as shown in FIG. 4, in a case in which the first region includes a plurality of sub-regions, it is preferable that the offset addition unit adds a different offset values for each sub-region. As a result, the image processing apparatus can reduce the gap in three-dimensional data regardless of the degree of far-near conflict with the second region in each sub-region by adding different offset values to each sub-region, even if the degree of far-near conflict with the second region differs for each sub-region.

### <Point Cloud Generation Process Step S103>

Step S103 is executed by a point cloud generation unit within the image processing apparatus. In step S103, the point cloud generation unit converts the distance distribution information processed in step S102 into a point cloud by point cloud generation.

The distance distribution information that has been acquired as a result of distance measurement by a distance distribution information acquisition unit is typically obtained by perspective projection. Accordingly, the point cloud generation unit can convert the distance distribution information into a point cloud, which is a set of coordinates of points in a three-dimensional space, by back projecting the distance distribution information based on various conditions applied when the distance distribution information is acquired.

The Z coordinate among the X coordinate, the Y coordinate, and the Z coordinate of each point included in the point cloud is the distance itself included in the distance distribution information. The X coordinate of each point included in the point cloud is calculated by Formula (1) below.

$$X = Z ( u , v ) \times ( u - {u}_{c} ) / f \qquad Formula ( 1 )$$

Additionally, the Y coordinate of each point included in the point cloud is calculated by Formula (2) below. Formula (1) and Formula (2) include coordinates (u, v) of a pixel referenced from the end point of the distance distribution information, coordinates (u_{c}, v_{c}) of a pixel corresponding to the center of the distance distribution information, a focal length f of the distance distribution information acquisition unit, and a distance Z (u, v) at the coordinates (u, v).

$$Y = Z ( u , v ) \times ( v - {v}_{c} ) / f \qquad Formula ( 2 )$$

### <Surface Generation Process>

The image processing apparatus may execute the surface generation process after the point cloud generation process of step S103 as shown in FIG. 1. The surface generation process is executed by a surface generation unit within the image processing apparatus.

In the surface generation process, the surface generation unit generates three-dimensional data having a surface by connecting three or four adjacent points as polygons to form a mesh.

Additionally, if color distribution information that is the same viewpoint as the distance distribution information is present, the surface generation unit can generate three-dimensional data with color information by assigning the color distribution information as a texture to the surface.

### [Modification 1]

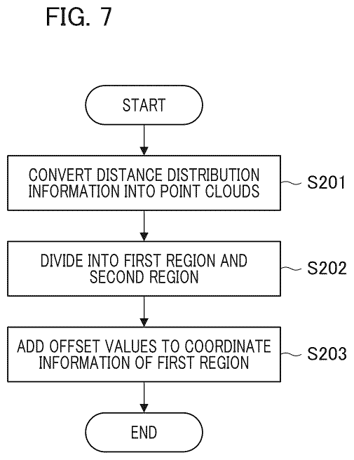

The effects as described above can also be obtained by an invention that is different from the invention that has been explained with reference to FIG. 1 to FIG. 6. Next, Modification 1 of the embodiment will be explained with reference to FIG. 7. FIG. 7 is a flowchart illustrating an example of three-dimensional data generation processing according to a modification of the embodiment.

In step S201, the point cloud generation unit converts the distance distribution information into a point cloud. Step S201 is a process similar to step S103 as described above.

In step S202, the region division unit divides the point cloud, which is an example of the coordinate information of the object, into the first region and the second region. The region division unit can execute region division by, for example, referring to the point cloud and applying segmentation based on deep learning.

The region division unit can appropriately execute region division by using a model that has learned to assign different labels to regions including hands and arms and regions other than the hand and arm regions in a case in which the object is a person.

In step S203, the offset addition unit adds an offset value to the coordinate information of the first region. In addition, in Modification 1 of the embodiment, the coordinate information of the object is the coordinate of each point included in the point cloud. Note that the offset value may be calculated based on the distance distribution information or may be calculated based on the coordinate of each point included in the point cloud.

Additionally, in a case in which the offset addition unit calculates the offset value based on the distance distribution information, the offset addition unit may calculate the offset value by a method similar to the method as described above. The offset addition unit uniformly adds an offset value to the Z coordinate that is a coordinate parallel to the optical axis of the point cloud that belongs to the first region.

In a case in which the offset addition unit calculates the offset value based on the coordinate of each point included in the point cloud, it may calculate offset values for each of the X direction, the Y direction, and the Z direction so as to minimize the gap in the far-near conflict edge.

For example, the offset addition unit identifies, for each point of the set U₁ of points close to the far-near conflict edge among the points that belong to the first region, the nearest neighboring point of the set U₂ of points close to the far-near conflict edge among the points that belong to the second region, and evaluates the Euclidean distances to the nearest neighboring point.

Next, the offset addition unit employs the mean distance of all the points in set U₁ as an index. Then, the offset addition unit may calculate offset values for each of the X direction, the Y direction, and the Z direction so that the index is minimized by adding the offset values to the three-dimensional coordinates of each point that constitutes the point cloud of the first region.

Note that the offset addition unit may calculate the offset value by a method other than the method as described above. For example, the offset addition unit may determine the index as described above by using points randomly sampled from among the points included in the set U₁, instead of all the points included in the set U₁.

Additionally, the offset addition unit may evaluate, for example, a difference in the Z coordinates, instead of the Euclidean distance. In a case in which the offset addition unit evaluates the difference in the Z coordinate, the offset addition unit sets the offset value in the X direction and the offset value in the Y direction to zero.

### [Modification 2]

In addition to the above described processing, the image processing apparatus can generate more suitable three-dimensional data with reduced sense of incongruity by applying a filtering processing to the region including the first neighboring region and the second neighboring region within the coordinate information.

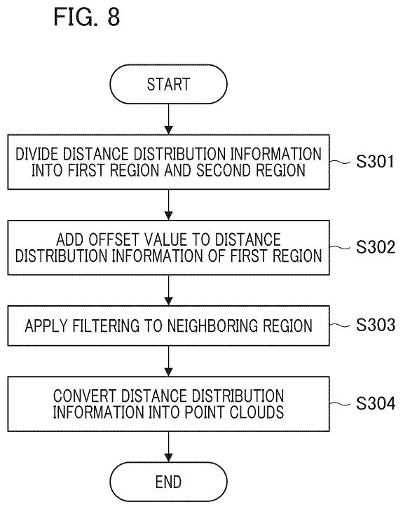

Therefore, Modification 2 of the embodiment will now be explained with reference to FIG. 8. FIG. 8 is a flowchart illustrating an example of three-dimensional data generation processing according to another modification of the embodiment.

In step S301, the region division unit divides the distance distribution information into a first region and a second region. Step S301 is a process similar to step S101 as described above.

In step S302, the offset addition unit adds an offset value to the distance distribution information of the first region. Step S302 is a process similar to step S102 as described above.

Step S303 is executed by a filtering application unit included in the image processing apparatus. In step S303, the filtering application unit applies filtering processing to the regions including the first neighboring region and the second neighboring region within the coordinate information.

The difference in distance in the Z direction around the far-near conflict edge is reduced by the addition of the offset value, but rarely becomes zero and often remains to some extent. However, the filtering application unit can smooth the difference by executing the process of step S303 and can generate even more suitable three-dimensional data with reduced sense of incongruity. Additionally, the filtering processing is, for example, the processing of applying a smoothing filter or an intermediate value filter.

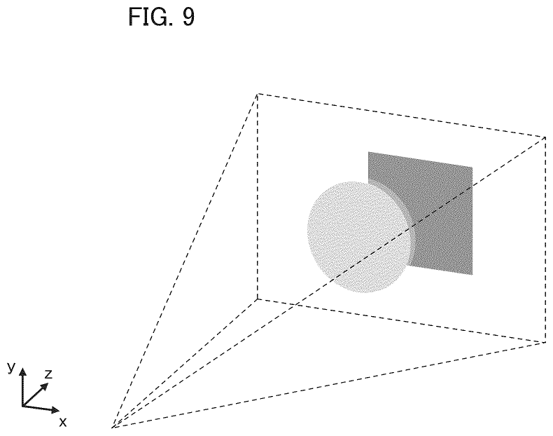

FIG. 9 is a diagram for explaining that the appearance of the occluding region is reduced by the addition of the offset value according to another modification of the embodiment. FIG. 9 is a perspective view showing three-dimensional data generated by applying the processes as shown in FIG. 8 to the distance distribution information as shown in FIG. 2A.

The three-dimensional data as shown in FIG. 9 exhibits a more continuous transition in distance in the Z-direction around the far-near conflict edge compared to the three-dimensional data as shown in FIG. 5B, and as a result, gaps are hardly visible, and the sense of incongruity is further reduced.

### [Modification 3]

The distance distribution information of the first region is denoted by Z₁ (u, v), the distance distribution information that results from adding the offset value to Z1 (u, v) is denoted by Z₁′ (u, v), and the distance distribution information used when calculating the coordinates in the direction orthogonal to the optical axis direction in the point cloud generation performed by the point cloud generation unit is denoted by Z₁″ (u, v).

In this case, it is preferable that the difference between Z₁ (u, v) and Z₁′ (u, v) is greater than the difference between Z₁ (u, v) and Z₁″ (u, v). The reason for this will now be explained.

As described above, in the point cloud generation process of step S103, the X-coordinate, which is a coordinate in a direction orthogonal to the optical axis, is calculated using Formula (1), and the Y-coordinate, which is a coordinate in a direction orthogonal to the optical axis, is calculated using Formula (2) is calculated using Formula (2).

The left border in a case in which Z₁ (u, v) is substituted for Z (u, v) in Formula (1) is denoted as X₁, the left border in a case in which Z₁′ (u, v) is substituted for Z (u, v) in Formula (1) is denoted as X₁′, and the left border in a case in which Z₁″ (u, v) is substituted for Z (u, v) in Formula (1) is denoted as X₁″. In this case, since Z₁≠Z₁′, it follows that X₁≠X₁′.

Z₁ (u, v) represents the distance distribution of the object in the Z direction at the time at which the distance distribution information is acquired. Therefore, X₁ represents the distance distribution of the object in the X direction at the time at which the distance distribution information is acquired.

In contrast, Z₁′ (u, v) is obtained by adding an offset value to Z₁ (u, v) to correct the distance distribution of the object. Therefore, X₁′ does not represent the distance distribution of the object in the X direction at the time at which the distance distribution information is acquired, and considering Formula (1), X₁′ is larger than X₁.

In other words, X₁′ represents the distance distribution of the object in the X direction at the time the distance distribution information is acquired, which is expanded compared to X₁, potentially causing a sense of incongruity for those viewing the three-dimensional data.

Consequently, it is preferable that the distance distribution information Z₁″ (u, v) used when calculating the X coordinate and the Y coordinate of the point cloud in the first region is closer to Z₁ (u, v) than the Z₁′ (u, v) to which the offset value is added. Additionally, it is more preferable that Z₁″ (u, v) is equal to Z₁ (u, v).

The examples of an index for evaluating the magnitude relation between the difference Z₁(u, v) and Z₁′(u, v) and the difference between Z₁(u, v) and Z₁″ (u, v) include the mean error and the root mean square error. Additionally, in a case in which the mean error is employed as the index, the condition that the difference between Z₁ (u, v) and Z₁′ (u, v) is greater than the difference between Z₁ (u, v) and Z₁″ (u, v) is expressed by Formula (3) below.

$$\text{?} \vert {Z}_{1} ( u , v ) - {Z}_{1}^{″} ( u , v ) \vert < {\sum }_{u , v} \vert {Z}_{1} ( u , v ) - {Z}_{1}^{″} ( u , v ) \vert \qquad Formula ( 3 )$$

$$\text{?} \text{indicates text missing or illegible when filed}$$

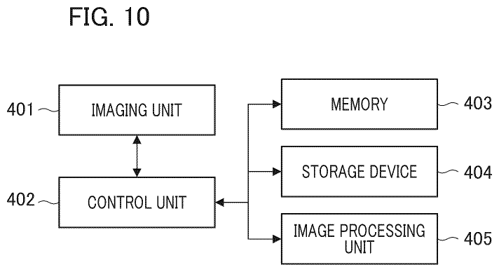

Next, an example of a hardware configuration of the image processing apparatus will be explained with reference to FIG. 10. FIG. 10 is a diagram illustrating an example of the hardware configuration of the image processing apparatus according to the embodiment. The image processing apparatus includes an imaging unit 401, a control unit 402, a memory 403, a storage device 404, and an image processing unit 405 as shown in FIG. 10.

The imaging unit 401 functions as a distance distribution information acquisition unit that acquires distance distribution information and color distribution information of an object. The control unit 402 is a control device such as a central processing unit (CPU) and controls the operation of each block within the image processing apparatus.

For example, the control unit 402 transmits the information such as the distance distribution information and the color distribution information acquired by the imaging unit 401 to the image processing unit 405, and stores information processed by the image processing unit 405 in the storage device 404.

The memory 403 is, for example, a volatile memory, and is used for temporarily storing information. The storage device 404 is, for example, a hard disk drive (HDD), and is used for storing permanent information.

The image processing unit 405 applies image processing such as the point cloud generation described above to the information including the distance distribution information and the color distribution information that have been acquired by the imaging unit 401. The image processing unit 405 may be realized as an integrated circuit or may be realized as a functional module by software. Additionally, the image processing unit 405 functions as the point cloud generation unit described above.

Note that, in the above embodiment, an example of the offset addition unit that adds an offset value to the coordinate information of the first region has been explained as the offset unit so that the distance between the first representative coordinate and the second representative coordinate is reduced. However, the offset unit may be an offset subtraction unit that subtracts an offset value from the coordinate information of the second region, and the offset unit includes an offset addition unit and an offset subtraction unit.

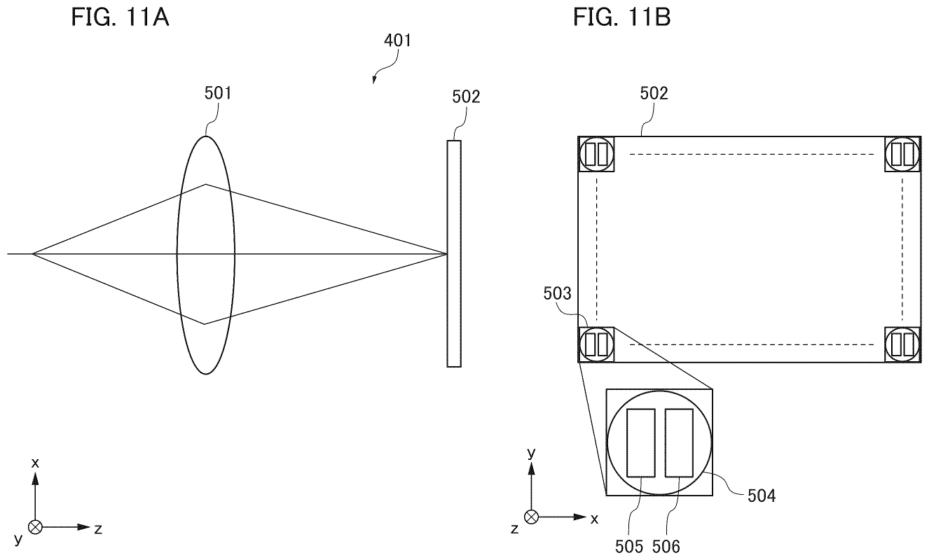

Next, an example of a configuration of the imaging unit 401 will be explained with reference to FIG. 11. The imaging unit 401 may have any configuration provided that it can function as a distance distribution information acquisition unit. Additionally, it is preferable that the imaging unit 401 is configured to be able to acquire both distance distribution information and color distribution information at the same time.

Examples of the imaging unit 401 having such a function include a stereo camera, a ToF camera, and an imaging element using the imaging plane phase difference ranging method. The stereo camera includes two imaging systems each having an optical system and an imaging element that enable acquisition of an RGB image. The ToF camera includes a ToF module that enables acquisition of distance distribution information and an imaging system that enables acquisition of an RGB image.

An imaging element using the imaging plane phase difference ranging method acquires distance distribution information of an object by providing, for each pixel, a first photoelectric conversion unit and a second photoelectric conversion unit that receive light passing through different pupil positions of an optical system. In the explanation below, a configuration of the imaging unit 401 that enables acquisition of the distance distribution information and the color distribution information at the same time by the imaging plane phase difference ranging method will be described as an example.

FIG. 11 is a diagram showing an example of an imaging unit according to the embodiment. FIG. 11A shows an imaging optical system 501 and an imaging element 502 that are part of the imaging unit 401. FIG. 11B shows an example of a configuration of the imaging element 502.

As shown in FIG. 11A, the imaging optical system 501 collects light from an object located on an object plane, and exposes the imaging element 502 that is substantially optically conjugate to the object plane, thereby capturing an image.

As shown in FIG. 11B, the imaging element 502 has a structure in which, for example, about several tens of millions of pixels 503, which are photoelectric conversion elements, are arranged in a grid pattern. Additionally, the imaging element 502 has a configuration in which color filters that transmit specific wavelengths such as red, green, and blue are arranged in a Bayer array in each pixel 503, thereby making it possible to acquire color distribution information.

As shown in FIG. 11B, each of the pixels 503 is configured to include a microlens 504, a first photoelectric conversion unit 505, and a second photoelectric conversion unit 506, and acquires two pieces of light information that is different from each other by the photoelectric conversion unit 505 and the photoelectric conversion unit 506 that are arranged in the X direction.

The imaging unit 401 acquires a first image configured as a luminance distribution of light received by the first photoelectric conversion unit 505 and a second image configured as a luminance distribution of light that has been received by the second photoelectric conversion unit 506 from light information that has been acquired by each of the pixels 503.

The incident surface of the imaging element 502 and the light receiving surfaces of the photoelectric conversion unit 505 and the photoelectric conversion unit 506 have a substantially Fourier conjugate relation due to the microlens 504. Therefore, the light receiving surface of the photoelectric conversion unit and the exit pupil of the imaging optical system 501 are in a substantially optically conjugate relation.

The position distribution in the exit pupil corresponds to the position distribution on the light receiving surfaces of the photoelectric conversion unit 505 and the photoelectric conversion unit 506. Consequently, the imaging unit 401 can separate and receive light fluxes that have transmitted different pupil regions by having two different photoelectric conversion unit 505 and photoelectric conversion unit 506. The first image and second image described above are luminance distribution information, wherein each of the first image and the second image is obtained from respective light fluxes that have passed through different pupil regions.

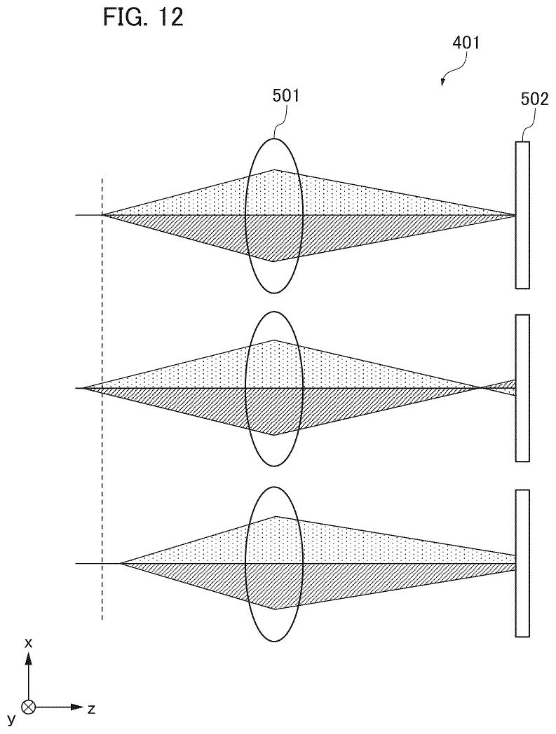

FIG. 12 is a diagram illustrating an example of a relation between a defocus amount and an image shift amount of the imaging unit according to the embodiment. As illustrated in the upper diagram of FIG. 12, in an ideal case, light rays forming an image on the imaging plane are incident on the same point of the imaging element 502 regardless of the passing position on the pupil.

However, as shown in the middle diagram or the lower diagram of FIG. 12, in a case in which the light ray is defocused, the point at which the light ray is incident on the imaging element 502 changes depending on the passing position on the pupil. That is, in the case of defocus, an image shift corresponding to the defocus amount occurs.

If the distance distribution information acquisition unit can calculate the image shift amount of this image shift, it can acquire the distance distribution information by converting the image shift amount into the defocus amount. The distance distribution information acquisition unit can calculate the image shift amount by, for example, executing stereo matching between the first image and the second image.

The distance distribution information acquisition unit can calculate the image shift amount by executing matching for a patch in a micro region of one image along the direction of the epipolar line in the other image and identifying the position with the highest correlation. Additionally, the distance distribution information acquisition unit converts the image shift amount into a defocus amount by using an optical parameter, for example, a focal length based on the image shift amount.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image processing apparatus and the like through a network or various storage media. Then, a computer (or a CPU, an MPU, or the like) of the image processing apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-012251, filed on Jan. 30, 2024, which is hereby incorporated by reference herein in its entirety.

What is claimed is:

1. An image processing apparatus comprising:
at least one processor or circuit configured to function as:
a distance distribution information acquisition unit configured to acquire distance distribution information of an object based on an object image formed by an optical system;
a region division unit configured to divide coordinate information of the object into a first region and a second region; and
an offset unit configured to decrease a distance in an optical axis direction of the optical system between a first representative coordinate representing a coordinate of the first region and a second representative coordinate representing a coordinate of the second region.

2. The image processing apparatus according to claim 1, wherein the offset unit adds a predetermined offset value to the coordinate information of the first region.

3. The image processing apparatus according to claim 1, wherein the region division unit divides the coordinate information of the object into the first region and the second region so that an occluding region that occludes an occluded region in which the coordinate information of the object cannot be acquired by the distance distribution information acquisition unit is included in the first region.

4. The image processing apparatus according to claim 1
wherein the region division unit divides the coordinate information of the object into the second region and the first region including a plurality of sub regions that are not connected to each other, and
wherein the offset unit adds a different offset value for each of the sub-regions.

5. The image processing apparatus according to claim 1, wherein the coordinate information of the object is three-dimensional coordinate of each point constituting a point cloud.

6. The image processing apparatus according to claim 1,
wherein the coordinate information of the object corresponds to the distance distribution information acquired by the distance distribution information acquisition unit, and
wherein the at least one processor or circuit is further configured to function as a point cloud generation unit configured to convert the distance distribution information into a point cloud.

7. The image processing apparatus according to claim 6, wherein a difference between the distance distribution information of the first region and the distance distribution information obtained by adding the offset value to the distance distribution information of the first region is larger than a difference between the distance distribution information of the first region and the distance distribution information used when calculating a coordinate in a direction orthogonal to an optical axis direction in point cloud generation performed by the point cloud generation unit.

8. The image processing apparatus according to claim 1,
wherein the first representative coordinate is a statistical amount of a coordinate of a first neighboring region located near a boundary with the second region within the first region, and
wherein the second representative coordinate is a statistical amount of a coordinate of a second neighboring region located near a boundary with the first region within the second region.

9. The image processing apparatus according to claim 8, wherein the at least one processor or circuit is further configured to function as a filtering application unit configured to apply filtering processing to a region including the first neighboring region and the second neighboring region in the coordinate information.

10. A non-transitory computer-readable storage medium storing a computer program including instructions for executing following processes:
acquiring distance distribution information of an object based on an object image formed by an optical system;
dividing coordinate information of the object into a first region and a second region; and
decreasing a distance in the optical axis direction of the optical system between a first representative coordinate representing a coordinate of the first region and a second representative coordinate representing a coordinate of the second region.

11. A three-dimensional data generation method comprising
acquiring distance distribution information of an object based on an object image formed by an optical system;
dividing coordinate information of the object into a first region and a second region; and
reducing a distance in the optical axis direction of the optical system between a first representative coordinate representing a coordinate of the first region and a second representative coordinate representing a coordinate of the second region.
